(19) United States
(12) Patent Application Publication
(10) Pub. No.: US 2025/0079891 A1
(43) Pub. Date: Mar. 6, 2025

(54) Wearable and Mountable Induction Charger for Smartwatches

(71) Applicant: Demi BESARD, Adliswil (CH)

(72) Inventor: Demi BESARD, Adliswil (CH)

(21) Appl. No.: 18/554,112

(22) PCT Filed: Apr. 7, 2022
(86) PCT No.: PCT/CH2022/000004

§ 371 Date: Oct. 5, 2023

(30) Foreign Application Priority Data
Apr. 9, 2021 (CH) 370/21

(51) Int. Cl. H02J 50/10; H02J 7/00

(52) U.S. Cl. CPC H02J 50/10; H02J 7/0044

(57) ABSTRACT

The invention relates to a wearable and mountable inductive charging station (1) that has an inductive charging module (2) and a power connection (3) that can be attached (4) to a smartwatch (5). When charging the battery of the smartwatch, the wearable and mountable inductive charging station (1) feeds the smartwatch's battery with power through the power connection (3). This means the smartwatch (5) does not need to be removed when charging its battery. Furthermore, it allows the wearer of a smartwatch (5) to charge its battery even while on the move or in remote places. Moreover, it enables the wearer of a smartwatch (5) to always carry a charging station with them, always having the possibility to charge their smartwatch (5). This is a significant advantage since conventional charging stations do not have an inductive charging module (2).

### TECHNICAL FIELD

Charging stations

### STATE OF THE ART

Inductive charging stations are already part of the prior art. Smartwatches that exclusively require inductive charging stations to charge their batteries depend on them.

### OBJECT OF THE INVENTION

Since most commercially available smartwatches require an induction charging station to charge the battery, the smartwatch must be taken off and placed on the station each time it is to be charged. However, as a watch wearer, you don't want to take the watch off your wrist every time. This also makes it difficult to keep the watch on the wrist overnight, as this is often the time chosen to recharge the watch. However, this eliminates many of the benefits of a smartwatch and works against the intuition of a watch wearer.

### BRIEF DESCRIPTION OF THE INVENTION

With a wearable & mountable induction charging station, the smartwatch does not have to be taken off every time to charge the battery, as the battery can be charged directly on the wrist.

### LIST OF DRAWINGS

The invention is explained in more detail with reference to an exemplary embodiment, which is illustrated in the drawings:

FIG. 1: Wearable & mountable induction charging station as seen from the induction charging station side.

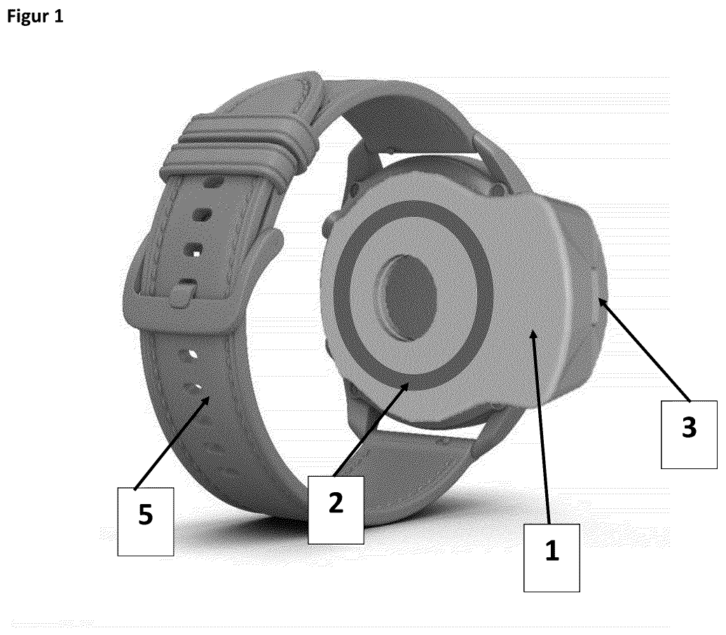

FIG. 2: Wearable & mountable induction charging station as seen from the dial side of the Smartwatch

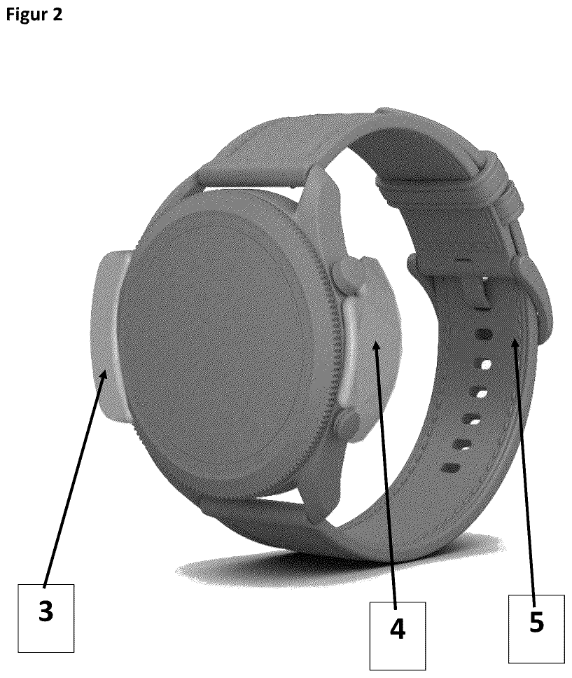

### DETAILED DESCRIPTION OF THE INVENTION

The portable and mountable induction charging station is mounted directly on the Smartwatch. It holds on to the frame of the Smartwatch.

A fully functional induction charging module is built into the socket, which connects to a power connector through which electricity can be fed to the induction charging module, which in turn charges the battery of the Smartwatch.

1. A wearable and mountable inductive charging station (1), configured to remain mounted on a smartwatch (5) while the smartwatch is worn, by directly attaching (4) the inductive charging station to the smartwatch (5), and to charge the smartwatch by means of an induction charging module (2) powered via a power connector (3) directly connected to the induction charging module (2).

2. The wearable and mountable induction charging station (1) according to claim 1, which is configured to be powered with electricity through the power connector (3), while the smartwatch is worn by a watch wearer, without having to take off the smartwatch.
